(19) United States
(12) Patent Application Publication
(10) Pub. No.: US 2010/0127867 A1
(43) Pub. Date: May 27, 2010

(54) Container transportation monitoring system

(75) Inventors: Chao-Heng Chien, Taipei city (TW); Pan-Chi Lee, Taipei city (TW)

Correspondence Address: BACON & THOMAS, PLLC, 625 SLATERS LANE, FOURTH FLOOR, ALEXANDRIA, VA, 22314-1176, US

(73) Assignee: Kuender Co., Ltd., Taipei City (TW)

(21) Appl. No.: 12/453,456

(22) Filed: May 12, 2009

(30) Foreign Application Priority Data
Nov. 26, 2008 (TW) 097145761

(51) Int. Cl. G08B 13/08; G08B 13/14; B60C 23/00; G08B 21/00

(52) U.S. Cl. 340/545.6; 340/568.1; 340/447; 340/431

(57) ABSTRACT

A container transportation monitoring system is disclosed, which comprises a wireless transmitting module, a wireless receiving module, and a monitoring center. The wireless transmitting module is located on a container, and the wireless receiving module is located on a container crane or a tractor. Besides, the wireless receiving unit of the wireless receiving unit receives the container information transmitted through the wireless transmitting unit of the wireless transmitting module, and the container information is then transmitted to the monitoring center through the monitoring transmitting unit. When the monitoring transmitting unit receives the container information, the container information is compared with the database container information stored in a database, and the comparing result is output to the monitoring device. Therefore, by the comparison process described above, the suspending process and the transportation process of the container is real-time monitored, and the mis-delivery of the container can be effectively avoided.

### BACKGROUND OF THE INVENTION

1. Field of the Invention

The present invention relates to a container transportation monitoring system and, more particularly, to a container transportation monitoring system which can monitor the loading process, the transportation process and the suspending process of a container.

2. Description of Related Art

During the transportation process of a container, the container crane plays an important role, since it suspends the container between the container ship and the trailer carrying the container. Due to human error or some other factors, error in the suspending process and the resulting mis-delivery of the container happens from time to time. This error can only be found when the container is opened at the recipient's location. As a result, lots of time, resources and human power is wasted due to the error in the suspending process.

Moreover, it is reported that some containers are seriously damaged by thieves when stealing the cargo therein during the transportation process or the storing period at the dock. The conventional alarm system of a container can only output an alarm signal for deterrence, it cannot record the incident and report to related agents. Therefore, intentional damage and theft from and of the container still happen occasionally.

As a result, a container transportation monitoring system, which can prevent errors occurring during the suspending process of a container, prevent the container from being broken into and actually stolen completely, and monitor the condition and position of the container is required in the industry.

### SUMMARY OF THE INVENTION

The object of the present invention is to provide a container transportation monitoring system which can prevent errors occurring during the suspending process of a container, prevent the container from being broken into and stolen completely, and monitor the condition and position of the container.

The container transportation monitoring system comprises a wireless transmitting module, a wireless receiving module, and a monitoring center. The wireless transmitting module is located on a container and includes a memory unit, a first processing unit, and a wireless transmitting unit. The first processing unit is electrically connected with the memory unit, and the wireless transmitting unit, wherein the first processing unit can read out container information from the memory unit, write in the container information to the memory unit, or transmit the container information by the wireless transmitting unit. The memory unit of the present invention can be one of the read-write non-volatile memory, flash memory, electronic programmable memory, and micro-hard disc.

Besides, the wireless receiving module is located on a container crane or a tractor, and includes a wireless receiving unit, a second processing unit, and a monitoring transmitting unit. The second processing unit is electrically connected with the wireless receiving unit, and the monitoring transmitting unit. The second processing unit controls the receiving of the container information of the wireless receiving unit, which is transmitted through the wireless transmitting unit of the wireless transmitting module. The second processing unit transmits the container information through the monitoring transmitting unit.

Moreover, the monitoring center includes a monitoring receiving unit, a central processing unit, a database, and a monitoring device, wherein the central processing unit is electrically connected with the monitoring receiving unit, the database, and the monitoring device. At least one item of database container information is stored in the database. When the monitoring receiving unit receives the container information from the monitoring transmitting unit of the wireless receiving module, the central processing unit compares the container information with the at least one item of database container information stored in the database, and outputs the result to the monitoring device. Therefore, by means of the comparison process described above, the suspending process and the transportation process of the container is real-time monitored, and the mis-delivery and or loss of the container can be effectively avoided.

The container information may include a serial number of the container, the type of the container, the size of the container, the type of the cargo contained in the container, the quantity of the cargo contained in the container, the shipper's name and address, the receiver's name and destination, the terminal harbor or the transit harbor, etc. The container information is used for checking whether the container is mis-delivered, and for recording and monitoring.

The database of the monitoring center may further comprise container scheduling information. The central processing unit compares the serial number of the container of the container information with the container scheduling information and outputs the comparing result to the monitoring device. The container scheduling information includes the suspending sequence for the container crane, for checking whether there is any error occurring during the suspending process.

More preferably, the wireless transmitting module of the present invention can further comprise a power switch located on the suspension point of the container or in the vicinity thereof. The power switch is used for turning on or turning off the power of the wireless transmitting module. When the container is suspended, the power of the wireless transmitting module is turned on and the container information is transmitted, otherwise the power of the transmitting module is turned off to make the wireless transmitting module be unable to transmit any signal. Therefore, the power for the operation of the wireless transmitting module can be saved, and the possible interference occurring during the receiving process of another container's information being handled, while another container is being suspended by the container crane. Similarly, when the container is positioned on a trailer, the power switch turns on the power of the wireless transmitting module for transmitting container information to the wireless receiving module located on a tractor. The container information is then transmitted to the monitoring center through the monitoring transmitting unit of the wireless receiving module. Therefore, the transportation process and the current position of the container can both be handled in real-time.

The wireless transmitting module of the present invention can further comprise an input unit, for inputting the container information. That is, the container information can be written-in or input through the input unit, and the container information is then written-in and stored in the memory unit. However, an input unit may be a cable connection unit (such as USB port or RS-232 port), a wireless connection unit (such as IR port, Bluetooth port, RF port or any equivalent device) or the equivalent device of both the cable connection unit and the wireless connection unit.

The wireless transmitting module of the present invention can further comprise a detecting unit located on the door of the container or in the vicinity thereof. The detecting unit is used for detecting the open/closed status of the door of the container. The detecting unit may be a non-contact type detector, a contact type detector (such as an IR detector) or the equivalent device of both the non-contact type detector and the contact type detector. The wireless transmitting module of the present invention can further comprise an alarm unit. As a result, once the container door is abnormally opened the, the alarm unit outputs an alarm signal. In the present invention, the alarm unit is a buzzer and the alarm signal is an alarm sound effect.

The wireless transmitting module of the present invention can further comprise a GPS unit, for calculating the position information of the container. The first processing unit stores the position information in the memory unit. Therefore, the transportation process and the status of the container can be recorded in detail by the GPS unit. Of course, the position information of the container can be transmitted to the monitoring center in real-time, for real-time tracking of the container.

The wireless transmitting module of the present invention can further comprise a wireless tire pressure receiving unit, for detecting the status of tire pressure of the plural tires of the trailer carrying the container and of the plural tires of the tractor. Each of these tires is equipped with a tire pressure detector, for transmitting the tire pressure status of these tires to the wireless tire pressure receiving unit by the wireless communication method.

The monitoring transmitting unit of the wireless receiving module of the present invention can be a general packet radio service (i.e. the GPRS) receiving unit. The monitoring receiving unit of the monitoring center of the present invention can be a general packet radio service (i.e. the GPRS) receiving unit. Of course, other kinds of wireless transmission method can be used, such as the 3G, the WI-Fi, or the WiMAX. Moreover, cable transmission can also be used, such as fiber optics cable transmission, coaxial cable transmission, or the ethernet cable transmission. The wireless transmitting unit of the present invention can be an RF open band frequency shift keying (i.e. the FSK) transmitting unit. The wireless receiving unit of the present invention can be an RF open band frequency shift keying (i.e. the FSK) receiving unit.

Other objects, advantages, and novel features of the invention will become more apparent from the following detailed description when taken in conjunction with the accompanying drawings.

### BRIEF DESCRIPTION OF THE DRAWINGS

FIG. 1 is a system diagram of the container transportation monitoring system according to one embodiment of the present invention.

FIG. 2 is a perspective view of the container transportation monitoring system according to one embodiment of the present invention.

FIG. 3 is a flowchart of the container transportation monitoring system according to one embodiment of the present invention.

FIG. 4 is an incident reporting flowchart of the container transportation monitoring system according to one embodiment of the present invention.

FIG. 5 is a system diagram of the container transportation monitoring system according to another embodiment of the present invention.

FIG. 6 is a perspective view of the container transportation monitoring system according to another embodiment of the present invention.

FIG. 7 is a flowchart of the container transportation monitoring system according to another embodiment of the present invention.

FIG. 8 is an incident reporting flowchart of the container transportation monitoring system according to another embodiment of the present invention.

FIG. 9 is an incident reporting flowchart of the container transportation monitoring system according to yet another embodiment of the present invention.

### DETAILED DESCRIPTION OF THE PREFERRED EMBODIMENT

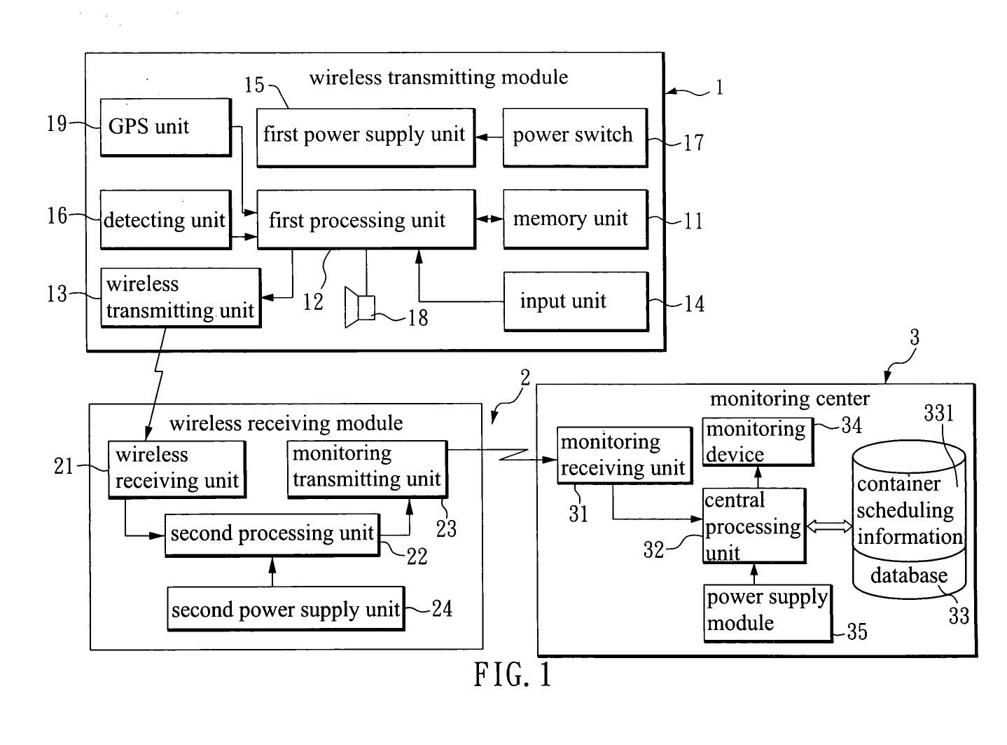

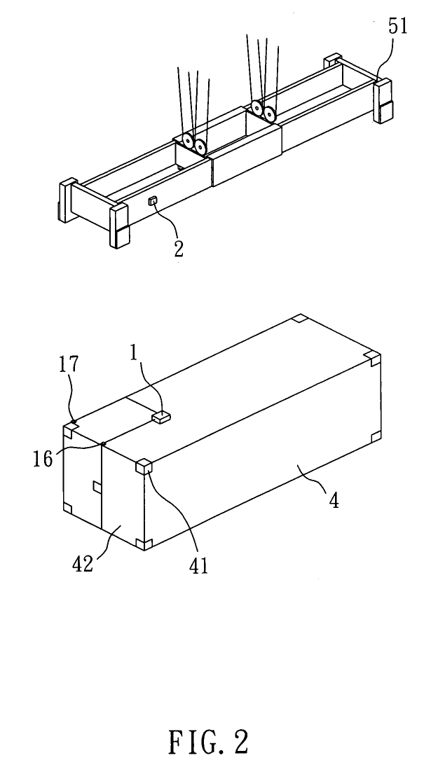

With reference to FIG. 1, and FIG. 2, wherein FIG. 1 is a system diagram of the container transportation monitoring system according to one embodiment of the present invention, while FIG. 2 is a perspective view of the container transportation monitoring system according to one embodiment of the present invention. As shown in the figures, a wireless transmitting module 1 is located on a container 4. The wireless transmitting module 1 includes a memory unit 11, a first processing unit 12, a wireless transmitting unit 13, an input unit 14, a first power supply unit 15, a detecting unit 16, a power switch 17, an alarm unit 18, and a GPS unit 19, wherein the memory unit 11, the wireless transmitting unit 13, the input unit 14, the first power supply unit 15, the detecting unit 16, the power switch 17, the alarm unit 18, and the GPS unit 19 are electrically connected with the first processing unit 12, respectively. The first power supply unit 15 provides the power for the operation of the whole wireless transmitting module 1.

The first processing unit 12 controls the read out process of the container information from the memory unit 11, or the write in process of the container information to the memory unit 11. Besides, the container information is transmitted through the wireless transmitting unit 13. The container information may include a serial number of the container, the type of the container (such as refrigerated container or ordinary container), the size of the container, the type of the cargo contained in the container, the quantity of the cargo contained in the container, the shipper's name and address, the receiver's name and destination, the terminal harbor or the transit harbor, etc. Moreover, the container information may be input/written in through the input unit 14, and then be written in the memory unit 1 by the first processing unit 12. The input unit 14 may be a cable connection unit (such as USB port or RS-232 port) or a wireless connection unit (such as IR port, Bluetooth port, RF port or any equivalent device).

A power switch 17 is also shown in the figures, which is located in the vicinity of the suspension point 41 of the container 4. When the container crane 51 contacts and engages with the suspension point 41 of the container 4, the power switch 17 is triggered by the container crane 51 and turns on the power of the wireless transmitting module 1. Once the container 4 has been moved to a certain position by the container crane 51, the container crane 51 moves away from the suspension point 41 of the container 4, the power switch 17 turns off the power of the wireless transmitting module 1, making the wireless transmitting module 1 unable to transmit any signal. Therefore, the power for the operation can be saved, and possible interference from a second container simultaneously being handled by the container crane 51 can be avoided.

Besides, a detecting unit 16 is also shown in the figures, which is located on the door 42 of the container 4 or in the vicinity thereof, for detecting the open/closed status of the door 42 of the container 4. That is, the detecting unit 16 is used to detect the opening process and the closing process of the container door 42, and each of the opening process and the closing process is recorded in the memory unit 11. In the present embodiment, the detecting unit 16 is an IR detecting unit. That is, when the container door 42 is abnormally opened or opened unexpectedly, the light source of the IR detecting unit is blocked, resulting in an abnormal signal which is then transmitted to the first processing unit 12. The first processing unit 12 then writes in the abnormal signal in the memory unit 11, and controls the alarm unit 1 8 to output an alarm signal to notify related agents and to sound an alarm for deterrence. In the present embodiment, the alarm unit 18 is a buzzer and the alarm signal is an alarm sound effect.

Moreover, the wireless transmitting module 1 of the present embodiment further comprises a GPS unit 19, for calculating the position information of the container 4. The first processing unit 12 then stores the position information in the memory unit 11. Therefore, the transportation process, the transportation path and the status of the container 4 can be recorded in detail. Of course, the position information of the container 4 can be transmitted to the monitoring center 3 in real-time, for real-time tracking of the container 4. In the present embodiment, the wireless transmitting unit 13 is an RF open band frequency shift keying (i.e. the FSK) transmitting unit.

With reference to FIG. 1, and FIG. 2 again, a wireless receiving module 2 is also shown in the figures. The wireless receiving module 2 is located on the container crane 51 and comprises a wireless receiving unit 21, a second processing unit 22, a monitoring transmitting unit 23, and a second power supply unit 24. The second processing unit 22 is electrically connected with the wireless receiving unit 21, the monitoring transmitting unit 23, and the second power supply unit 24, respectively. The operation flow is as described below: the second processing unit 22 controls the receiving of the container information of the wireless receiving unit 21, which is transmitted through the wireless transmitting unit 13 of the wireless transmitting module 1, and transmits the container information through the monitoring transmitting unit 23. The second power supply unit 24 provides the power for the operation of the whole wireless receiving module 2. In the present embodiment, the wireless receiving unit 21 is an RF open band frequency shift keying (i.e. the FSK) receiving unit. The monitoring transmitting unit 23 is a general packet radio service (i.e. the GPRS) transmitting unit.

Besides, the monitoring center 3 includes a monitoring receiving unit 31, a central processing unit 32, a database 33, a monitoring device 34, and a power supply module 35. The central processing unit 32 is electrically connected with the monitoring receiving unit 31, the database 33, the monitoring device 34, and the power supply module 35. Moreover, at least one item of database container information is stored in the database 33. When the monitoring receiving unit 31 receives the container information from the monitoring transmitting unit 23 of the wireless receiving module 2, the central processing unit 32 compares the container information with the at least one item of database container information stored in the database 33, and outputs the result to the monitoring device 34.

The database 33 can further store container scheduling information 331. The central processing unit 32 compares the serial number of the container of the container information with the container scheduling information 331, and then outputs the comparing result to the monitoring device 34. The container scheduling information 331 mainly includes the suspending sequence for the container crane 51, for checking whether there is any error occurring during the suspending process. In the present embodiment, the monitoring receiving unit 31 is a general packet radio service (i.e. the GPRS) receiving unit, which is employed in the long distance transmission. However, in the present invention, the transmission of the container information is not limited to wireless transmission and the container information can also be transmitted by cable transmission, such as fiber optics cable transmission, coaxial cable transmission, or the ethernet cable transmission.

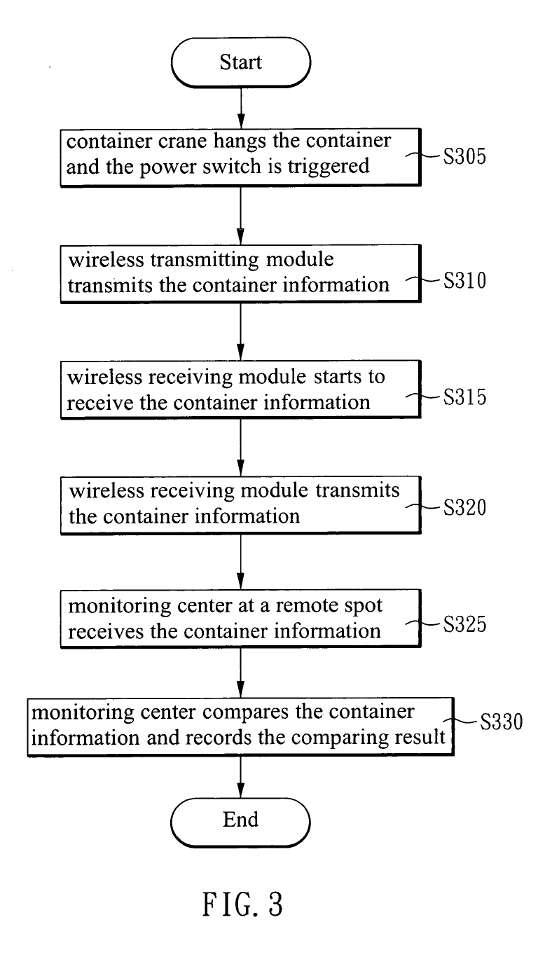

With reference to FIG. 3, which is a flowchart of the container transportation monitoring system according to one embodiment of the present invention, the operation flow of the present embodiment is described below:

When the container crane 51 contacts the container 4 and is ready for suspending the container 4, the power switch 17 is triggered by the container crane 51 (Step S305). At this time, the power of the wireless transmitting module 1 is turned on. The first processing unit 12 controls the wireless transmitting unit 13 to start the transmission of the container information (Step S310). The wireless receiving unit 21 of the wireless receiving module 2 located on the container crane 51 starts to receive the container information (Step S315). Besides, the second processing unit 22 also controls the monitoring transmitting unit 23 to transmit the container information (Step S320). At the time, the monitoring center 3 at a remote spot receives the container information through the monitoring receiving unit 31 (Step S325). The container information is then compared and the comparing result is recorded (Step S330).

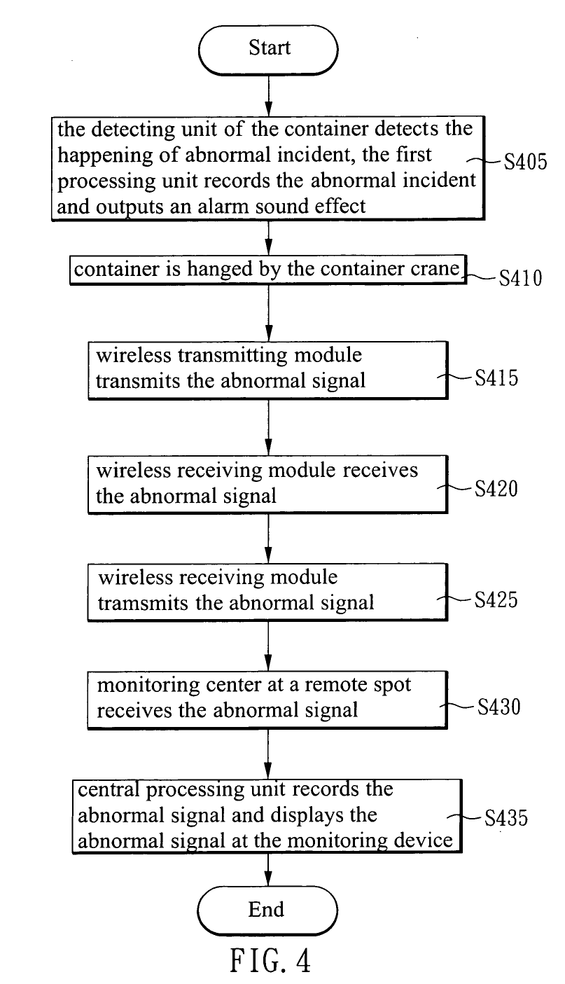

With reference to FIG. 4, which is an incident reporting flowchart of the container transportation monitoring system according to one embodiment of the present invention, the operation flow of the incident reporting process is described below:

During the transportation process and the storage of the container 4, once the container door 42 is abnormally opened or opened unexpectedly, the detecting unit 16 located on the container 4 will detect the happening of this incident, whereby the first processing unit 12 then records the time, and the position of this incident and outputs an alarm sound effect (Step S405). Once the container 4 is suspended by the container crane 51 (Step S410), the wireless transmitting module 1, which is triggered and turned on, outputs an abnormal signal (Step S415). The wireless receiving unit 21 of the wireless receiving module 2 located on the container crane 51 receives the abnormal signal (Step S420). Moreover, the second processing unit 22 also controls the monitoring transmitting unit 23 to transmit the abnormal signal (Step S425). At the time, the monitoring center 3 at a remote spot receives the abnormal signal through the monitoring receiving unit 31 (Step S430). The abnormal signal is recorded and displayed by the monitoring device 34, for reporting and alarming (Step S435).

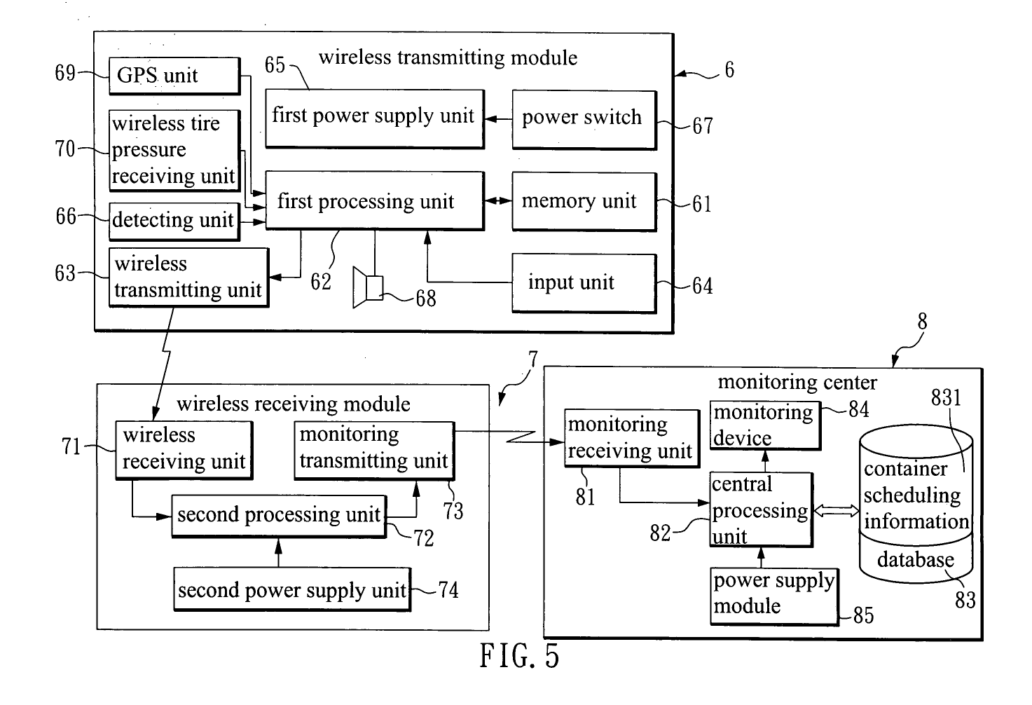

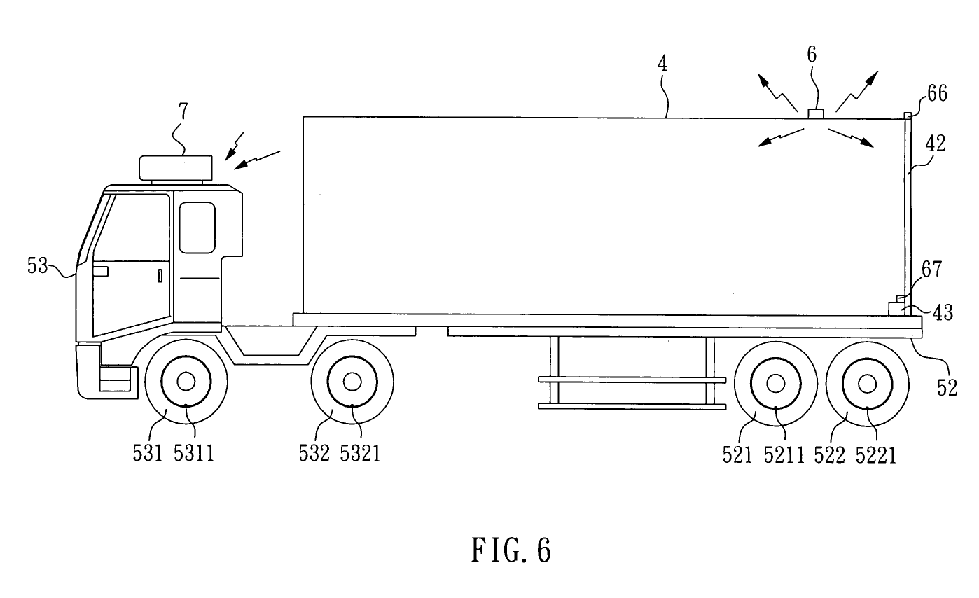

With reference to FIG. 5, and FIG. 6, wherein FIG. 5 is a system diagram of the container transportation monitoring system according to the other embodiment of the present invention, while FIG. 6 is a perspective view of the container transportation monitoring system according to another embodiment of the present invention. As shown in the figures, a wireless transmitting module 6 is located on a container 4. The wireless transmitting module 6 includes a memory unit 61, a first processing unit 62, a wireless transmitting unit 63, an input unit 64, a first power supply unit 65, a detecting unit 66, a power switch 67, an alarm unit 68, a GPS unit 69, and a wireless tire pressure receiving unit 70, wherein the memory unit 61, the wireless transmitting unit 63, the input unit 64, the first power supply unit 65, the detecting unit 66, the power switch 67, the alarm unit 68, the GPS unit 69, and the wireless tire pressure receiving unit 70 are electrically connected with the first processing unit 62, respectively. The first power supply unit 65 provides the power for the operation of the whole wireless transmitting module 6.

The first processing unit 62 controls the read out process of the container information from the memory unit 61, or the write in process of the container information to the memory unit 61. Besides, the container information is transmitted through the wireless transmitting unit 63. The container information may include a serial number of the container, the type of the container (such as a refrigerated container or ordinary container), the size of the container, the type of the cargo contained in the container, the quantity of the cargo contained in the container, the shipper's name and address, the receiver's name and destination, the terminal harbor or the transit harbor, etc. Moreover, the container information may be input/written in through the input unit 64, and then written in the memory unit 61 by the first processing unit 62. The input unit 64 may be a cable connection unit (such as USB port or RS-232 port) or a wireless connection unit (such as IR port, Bluetooth port, RF port or any equivalent device).

A power switch 67 is also shown in the figures, which is located in the vicinity of the fixing part 43 of the container 4. When the container 4 is suspended by the container crane (not shown in the figure) and located on a trailer 52 the power switch 67 of the wireless transmitting module 6 is contacted by the fixing bolt (not shown in the figure) of the trailer 52. The power switch 67 is thus triggered, and the power switch 67 turns on the power of the wireless transmitting module 6. The container information is then transmitted by the wireless transmitting module 6. After that, the power of the wireless transmitting module 6 is turned on periodically for transmitting the container information, under the control of a control program (not shown in the figures). In some cases, upon the request from a remote control center (not shown in the figure), the power of the wireless transmitting module 6 is turned on for transmitting the container information.

Besides, a detecting unit 66 is also shown in the figures, which is located on the door 42 of the container 4 or in the vicinity thereof, for detecting the open/closed status of the door 42 of the container 4. That is, the detecting unit 66 is used to detect the opening process and the closing process of the container door 42, and each of the opening process and the closing process is recorded in the memory unit 61. In the present embodiment, the detecting unit 66 is an IR detecting unit. That is, when the container door 42 is abnormally opened or opened unexpectedly, the light source of the IR detecting unit is blocked, resulting in an abnormal signal which is then transmitted to the first processing unit 62. The first processing unit 62 then writes in the abnormal signal in the memory unit 61, and controls the alarm unit 68 to output an alarm signal to notify related agents and to sound an alarm for deterrence. In the present embodiment, the alarm unit 68 is a buzzer and the alarm signal is an alarm sound effect.

Moreover, the wireless transmitting module 6 of the present embodiment further comprises a GPS unit 69, for calculating the position information of the container 4. The first processing unit 62 then stores the position information in the memory unit 61. Therefore, the transportation process, the transportation path and the status of the container 4 can be recorded in detail. Of course, the position information of the container 4 can be transmitted to the monitoring center 8 in real-time, for real-time tracking of the container 4. In the present embodiment, the wireless transmitting unit 63 is an RF open band frequency shift keying (i.e. the FSK) transmitting unit.

Moreover, the wireless transmitting module 6 of the present embodiment can further comprise a wireless tire pressure receiving unit 70, for detecting the status of tire pressure of the plural tires 521, 522 of the trailer 52 carrying the container 4 and the status of tire pressure of the plural tires 531, 532 of the tractor 53. Besides, each of these tires 521, 522, 531, 532 is equipped with a tire pressure detector (i.e. the tire pressure detector 5211, 5221, 5311, 5321), for transmitting the tire pressure status of these tires 521, 522, 531, 532 to the wireless tire pressure receiving unit 70, by the wireless communication method.

With reference to FIG. 5, and FIG. 6 again, a wireless receiving module 7 is also shown in the figures. The wireless receiving module 7 is located on a tractor 53 and comprises a wireless receiving unit 71, a second processing unit 72, a monitoring transmitting unit 73, and a second power supply unit 74. The second processing unit 72 is electrically connected with the wireless receiving unit 71, the monitoring transmitting unit 73, and the second power supply unit 74, respectively. The operation flow is as described below: the second processing unit 72 controls the receiving of the container information ofthe wireless receiving unit 71, which is transmitted through the wireless transmitting unit 63 of the wireless transmitting module 6, and transmits the container information through the monitoring transmitting unit 73. Besides, the second processing unit 72 also transmits tractor information through the monitoring transmitting unit 73. The second power supply unit 74 provides the power for the operation of the whole wireless receiving module 7. In the present embodiment, the wireless receiving unit 71 is an RF open band frequency shift keying (i.e. the FSK) receiving unit. The monitoring transmitting unit 73 is a general packet radio service (i.e. the GPRS) transmitting unit.

Besides, the monitoring center 8 includes a monitoring receiving unit 81, a central processing unit 82, a database 83, a monitoring device 84, and a power supply module 85. The central processing unit 82 is electrically connected with the monitoring receiving unit 81, the database 83, the monitoring device 84, and the power supply module 85. Moreover, at least one item of database container information and at least one item of database tractor information are stored in the database 83. When the monitoring receiving unit 81 receives the container information and the tractor information from the monitoring transmitting unit 73 of the wireless receiving module 7, the central processing unit 82 compares the container information and the tractor information with the at least one item of database container information and the at least one database tractor information stored in the database 83, respectively. The comparing results are then output to the monitoring device 84.

The database 83 can further store container scheduling information 831. The central processing unit 82 compares the serial number of the container of the container information with the container scheduling information 831, and then outputs the comparing result to the monitoring device 84. The container scheduling information 831 mainly includes the suspending sequence for the container crane (not shown in the figure), for checking whether there is any error occurring during the suspending process. In the present embodiment, the monitoring receiving unit 81 is a general packet radio service (i.e. the GPRS) receiving unit, which is employed in the long distance transmission. However, in the present invention, the transmission of the container information is not limited to wireless transmission, and the container information can also be transmitted by cable transmission, such as fiber optics cable transmission, coaxial cable transmission, or the ethernet cable transmission.

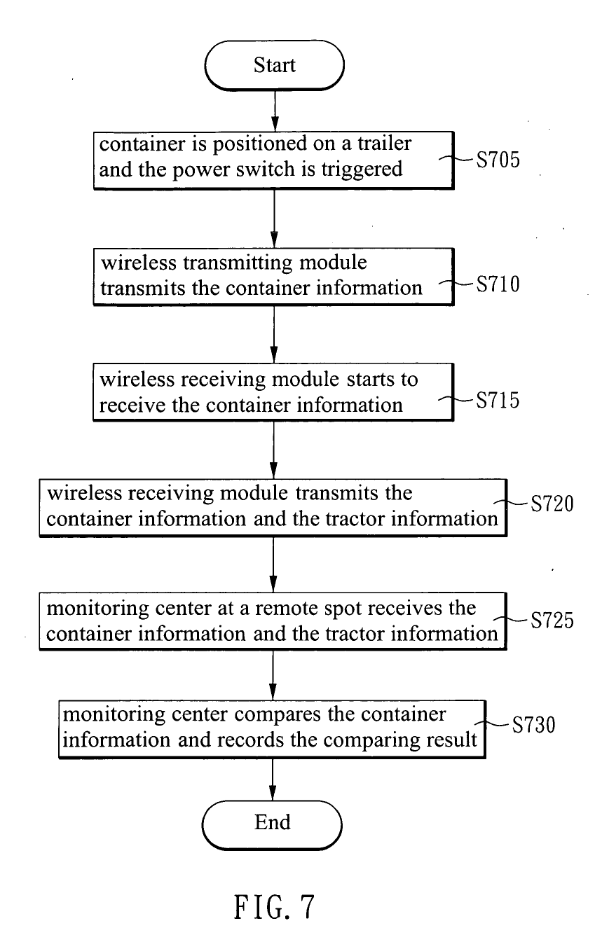

With reference to FIG. 7, which is a flowchart of the container transportation monitoring system according to another embodiment of the present invention, the operation flow of the present embodiment is described below:

When the container 4 is suspended by the container crane (not shown in the figure) and positioned on the trailer 52, the power switch 67 is triggered with the contact of the fixing bolt (not shown in the figure) of the trailer 52 (Step S705). At this time, the power of the wireless transmitting module 6 is turned on. The first processing unit 62 controls the wireless transmitting unit 63 to start the transmission of the container information (Step S710). The wireless receiving unit 71 ofthe wireless receiving module 7 located on the tractor 53 starts to receive the container information (Step S715). Besides, the second processing unit 72 also controls the monitoring transmitting unit 73 to transmit the container information and the tractor information (Step S720). At the time, the monitoring center 8 at a remote spot receives the container information and the tractor information through the monitoring receiving unit 81 (Step S725). The container information and the tractor information are then compared and the comparing result is recorded (Step S730).

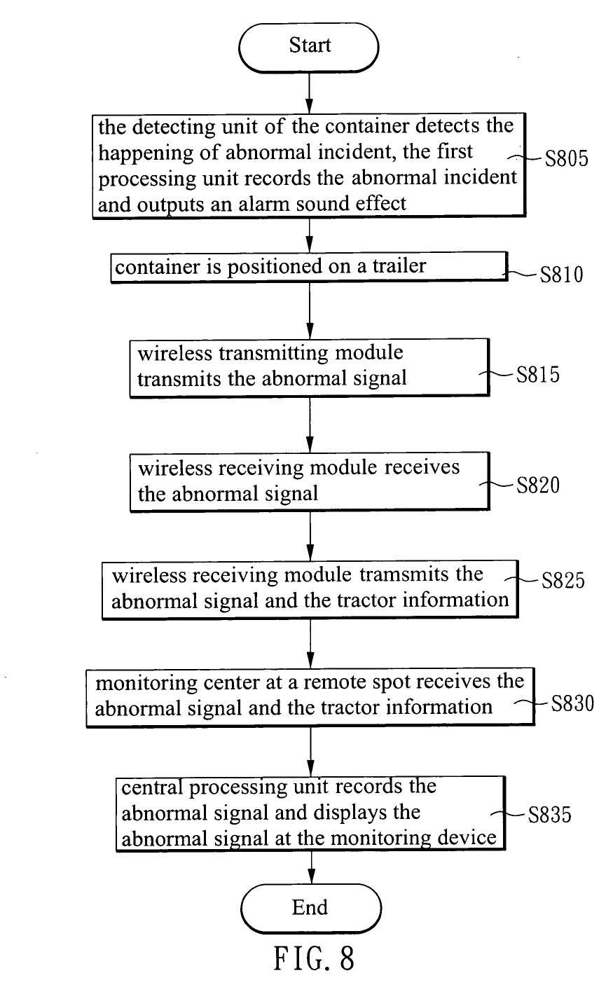

With reference to FIG. 8, which is an incident reporting flowchart of the container transportation monitoring system according to the another embodiment of the present invention, the operation flow of the incident reporting process is described below:

During the transportation process and the storage of the container 4, once the container door 42 is abnormally opened or opened unexpectedly, the detecting unit 66 located on the container 4 will detect the happening of this incident, the first processing unit 62 then records the time, and the position of this incident and outputs an alarm sound effect (Step S805). Once the container 4 is suspended by the container crane (not shown in the figure) and positioned on a trailer 52 (Step S810), the wireless transmitting module 6, which is triggered and turned on, outputs an abnormal signal (Step S815). The wireless receiving unit 71 of the wireless receiving module 7 located on the tractor 53 receives the abnormal signal (Step S820). Moreover, the second processing unit 72 also controls the monitoring transmitting unit 73 to transmit the abnormal signal and the tractor information (Step S825). At the time, the monitoring center 8 at a remote spot receives the abnormal signal and the tractor information through the monitoring receiving unit 81 (Step S830). The abnormal signal and the tractor information are recorded and displayed by the monitoring device 84, for reporting and alarming (Step S835).

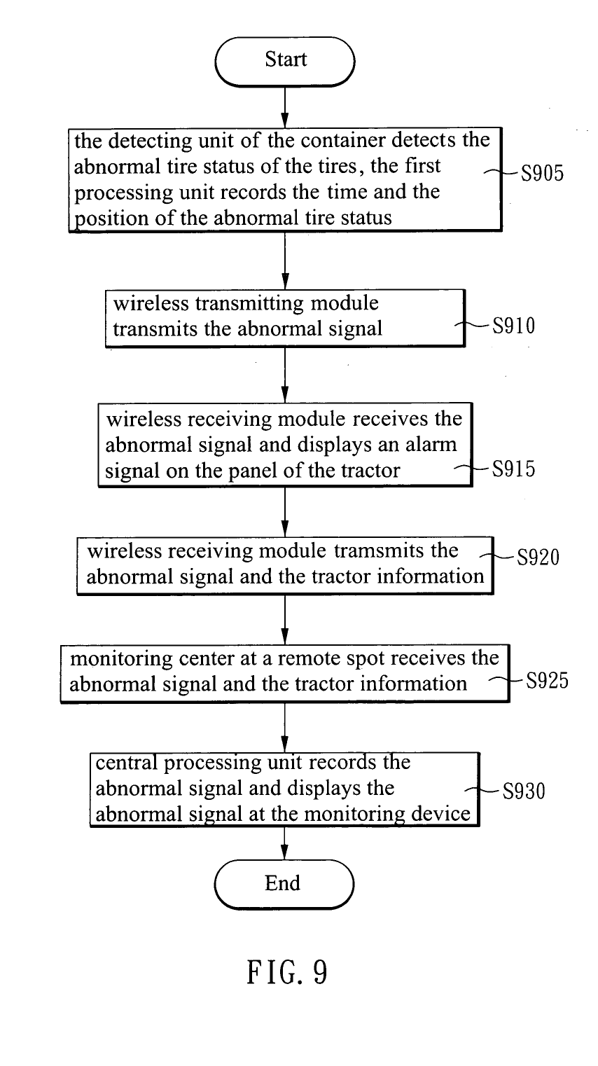

With reference to FIG. 9, which is an incident reporting flowchart of the container transportation monitoring system according to yet another embodiment of the present invention, the operation flow of the incident reporting process is described below:

During the transportation process and the storage of the container 4, once the status of tire pressure of the plural tires 521, 522 of the trailer 52 carrying the container 4 or the status of tire pressure of the plural tires 531, 532 ofthe tractor 53 is abnormal, the tire pressure detector 5211, 5221, 5311, 5321 of these tires 521, 522, 531, 532 will output an alarm signal to the wireless tire pressure receiving unit 70 of the wireless transmitting module 6 located on the container 4, while the first processing unit 62.recording the time, and the position of this incident (Step S905). Then, the wireless transmitting module 6 outputs an abnormal signal (Step S910). The wireless receiving unit 71 ofthe wireless receiving module 7 located on the tractor 53 receives the abnormal signal and displays an alarm signal on the panel of the tractor 53(Step S915). Moreover, the second processing unit 72 also controls the monitoring transmitting unit 73 to transmit the abnormal signal and the tractor information (Step S920). At the time, the monitoring center 8 at a remote spot receives the abnormal signal and the tractor information through the monitoring receiving unit 81 (Step S925). The abnormal signal and the tractor information are recorded and displayed by the monitoring device 84, for reporting and alarming (Step S930).

Although the present invention has been explained in relation to its preferred embodiment, it is to be understood that many other possible modifications and variations can be made without departing from the scope of the invention as hereinafter claimed.

What is claimed is:

1. A container transportation monitoring system comprising:
a wireless transmitting module locating on a container, the wireless transmitting module including a memory unit, a first processing unit, and a wireless transmitting unit, wherein the first processing unit is electrically connected with the memory unit, and the wireless transmitting unit, the first processing unit can read out container information from the memory unit, write in the container information to the memory unit, or transmit the container information by the wireless transmitting unit;
a wireless receiving module locating on a container crane, the wireless receiving module including a wireless receiving unit, a second processing unit, and a monitoring transmitting unit, wherein the second processing unit is electrically connected with the wireless receiving unit, and the monitoring transmitting unit, the second processing unit controls the receiving of the container information of the wireless receiving unit, which is transmitted through the wireless transmitting unit of the wireless transmitting module, and transmits the container information through the monitoring transmitting unit; and
a monitoring center including a monitoring receiving unit, a central processing unit, a database, and a monitoring device, wherein the central processing unit is electrically connected with the monitoring receiving unit, the database, and the monitoring device, at least one item of database container information is stored in the database; when the monitoring receiving unit receives the container information from the monitoring transmitting unit of the wireless receiving module, the central processing unit compares the container information with the at least one item of database container information stored in the database, and outputs the result to the monitoring device.

2. The container transportation monitoring system as claimed in claim 1, wherein the container information includes a serial number of the container.

3. The container transportation monitoring system as claimed in claim 2, wherein the database further comprises container scheduling information, and the central processing unit compares the serial number of the container of the container information with the container scheduling information, then the central processing unit outputs the comparing result to the monitoring device.

4. The container transportation monitoring system as claimed in claim 1, wherein the wireless transmitting module further comprises a power switch located on a suspension point of the container or in the vicinity thereof.

5. The container transportation monitoring system as claimed in claim 1, wherein the wireless transmitting module further comprises an input unit, for inputting the container information.

6. The container transportation monitoring system as claimed in claim 1, wherein the wireless transmitting module further comprises a detecting unit located on the door of the container or in the vicinity thereof, for detecting the open/closed status of the door of the container.

7. The container transportation monitoring system as claimed in claim 6, wherein the wireless transmitting module further comprises an alarm unit.

8. The container transportation monitoring system as claimed in claim 6, wherein the wireless transmitting module further comprises a GPS unit for calculating the position information of the container, and the first processing unit stores the position information in the memory unit.

9. The container transportation monitoring system as claimed in claim 1, wherein the monitoring transmitting unit is a general packet radio service transmitting unit, while the monitoring receiving unit is a general packet radio service receiving unit.

10. The container transportation monitoring system as claimed in claim 1, wherein the wireless transmitting unit is an RF open band frequency shift keying transmitting unit, while the wireless receiving unit is an RF open band frequency shift keying receiving unit.

11. A container transportation monitoring system comprising:
a wireless transmitting module locating on a container, the wireless transmitting module including a memory unit, a first processing unit, and a wireless transmitting unit, wherein the first processing unit is electrically connected with the memory unit, and the wireless transmitting unit, the first processing unit can read out container information from the memory unit, write in the container information to the memory unit, or transmit the container information by the wireless transmitting unit;
a wireless receiving module locating on a tractor, the wireless receiving module including a wireless receiving unit, a second processing unit, and a monitoring transmitting unit, wherein the second processing unit is electrically connected with the wireless receiving unit, and the monitoring transmitting unit, the second processing unit controls the receiving of the container information of the wireless receiving unit, which is transmitted through the wireless transmitting unit of the wireless transmitting module, and transmits the container information through the monitoring transmitting unit; and
a monitoring center including a monitoring receiving unit, a central processing unit, a database, and a monitoring device, wherein the central processing unit is electrically connected with the monitoring receiving unit, the database, and the monitoring device, at least one item of database container information is stored in the database; when the monitoring receiving unit receives the container information from the monitoring transmitting unit of the wireless receiving module, the central processing unit compares the container information with the at least one item of database container information stored in the database, and outputs the result to the monitoring device.

12. The container transportation monitoring system as claimed in claim 11, wherein the container information includes a serial number of the container.

13. The container transportation monitoring system as claimed in claim 12, wherein the monitoring transmitting unit of the wireless receiving module further transmits the tractor information to the monitoring receiving unit of the monitoring center.

14. The container transportation monitoring system as claimed in claim 13, wherein the database further comprises container scheduling information, and the central processing unit compares the serial number of the container of the container information and the tractor information with the container scheduling information, then the central processing unit outputs the comparing result to the monitoring device.

15. The container transportation monitoring system as claimed in claim 11, wherein the wireless transmitting module further comprises a power switch located on a suspension point of the container or in the vicinity thereof.

16. The container transportation monitoring system as claimed in claim 11, wherein the wireless transmitting module further comprises a detecting unit located on the door of the container or in the vicinity thereof, for detecting the open/closed status of the door of the container.

17. The container transportation monitoring system as claimed in claim 16, wherein the wireless transmitting module further comprises an alarm unit.

18.The container transportation monitoring system as claimed in claim 16, wherein the wireless transmitting module further comprises a GPS unit, for calculating the position information of the container, and the first processing unit stores the position information in the memory unit.

19.The container transportation monitoring system as claimed in claim 11, wherein the monitoring transmitting unit is a general packet radio service transmitting unit, while the monitoring receiving unit is a general packet radio service receiving unit.

20.The container transportation monitoring system as claimed in claim 11, wherein the wireless transmitting unit is an RF open band frequency shift keying transmitting unit, while the wireless receiving unit is an RF open band frequency shift keying receiving unit.

21. The container transportation monitoring system as claimed in claim 11, wherein the wireless transmitting module further comprises a wireless tire pressure receiving unit, for detecting the status of tire pressure of plural tires of a trailer carrying the container.

22. The container transportation monitoring system as claimed in claim 21, wherein the wireless tire pressure receiving unit is used to detect the status of tire pressure of plural tires of a tractor.
